(19) United States
(12) Patent Application Publication
(10) Pub. No.: US 2024/0335862 A1
(43) Pub. Date: Oct. 10, 2024

(54) TOOL FOR CLEANING ELECTRICALLY ENERGIZED EQUIPMENT

(71) Applicant: 2533702 ALBERTA INC., Spruce Grove (CA)

(72) Inventors: Brett Fleming, Spruce Grove (CA); Elton Hunter, Edmonton (CA)

(21) Appl. No.: 18/293,287

(22) PCT Filed: Jul. 14, 2022
(86) PCT No.: PCT/CA2022/051098

§ 371 Date: Jan. 29, 2024

Related U.S. Application Data
(60) Provisional application No. 63/227,017, filed on Jul. 29, 2021.

(51) Int. Cl. B08B 5/02; B24C 5/04

(52) U.S. Cl. CPC B08B 5/02; B24C 5/04

(57) ABSTRACT

A tool for cleaning electrically energized equipment. The tool has an elongate tubular body having a fluid input at a first end and a nozzle adapter at a second end. A first end of a nozzle is securable to the nozzle adapter. A bore extends through the body and terminates at a fluid output at a second end of the nozzle. The bore through the body, the fluid input, and the nozzle adapter has a generally circular cross-section. The fluid input has a fluid input transition to reduce the cross-sectional diameter of the bore therethrough in a direction toward the tubular body. The bore through the nozzle has a transition to alter the cross-sectional shape of the bore therethrough from generally circular to generally rectangular at the fluid output. Pressurized cleaning fluid delivered to the fluid input passes through the fluid output in a stream having a generally rectangular cross-section.

### FIELD

This invention relates generally to the field of cleaning industrial equipment and components, and in a particular embodiment to a tool that may be used for cleaning equipment or components that are electrically energized.

### BACKGROUND

Over time, exposure to the elements and to the ambient environment can cause electrical components to become dirty or covered or encrusted with dust, atmospheric contaminants, dead or nesting insects, bird droppings, etc. When such components have exposed electrical contacts or wiring, the build-up of dirt and debris on the component can create the potential for electrical short, arc, or in some cases a fire. It therefore becomes necessary on a periodic basis to clean such equipment or components to ensure their continued safe and efficient operation.

Where the components in issue comprise energized components in an industrial application or that are associated with a power grid, the components can typically be connected to a source of high voltage, making cleaning them both difficult and dangerous unless the source of electricity is turned off. Often, turning off the source electricity can be inconvenient and can have significant economic costs. For example, where the components in question are transformers, capacitors, switchgear, etc in an electrical substation, control center, etc, turning off the source of electricity feeding the components often means shutting down all or a portion of the substation or industrial plant, which may leave electrical customers without electricity for a length of time or force a shut-down of a plant or facility.

In an effort to provide a means to clean such components or equipment while energized, others have suggested blasting the components with abrasive media, such as ground corncobs, crushed walnut shells, etc. While such efforts have met with varying degrees of success, in each instance the cleaning media typically becomes intermixed with contaminants upon the component or equipment, and must be cleaned up and removed. In some cases the contaminants may contain environmentally hazardous goods, to the extent that the spent media and contaminant waste product must be collected and sent together to a center for processing hazardous or dangerous materials. For example, electrical components such as transformers, capacitors, switchgear, etc. can at times be coated with petroleum based products, silicone, etc. to help prevent oxidation and to extend their useful operating life. Such coatings can become mixed with the cleaning media and can present an environmental hazard. In other cases, the cleaning process may tend to cause paint applied to the component or equipment to flake off, representing a further contaminant. In still other instances very small portions of metal may ablate from a component being cleaned. In still other cases, environmental dust and debris on component may itself be hazardous (particularly in certain industrial applications).

There therefore exists a need for a safe and environmentally friendly manner to clean such components and equipment, particularly when they are in an energized state.

### SUMMARY

Accordingly, in one aspect the invention provides a tool for cleaning electrically energized equipment, the tool comprising an elongate tubular body having a cleaning fluid input at a first end and a nozzle adapter at a second end, the tubular body having a longitudinal bore extending from the first end to the second end, each of the cleaning fluid input and the nozzle adapter having a longitudinal bore aligned with the longitudinal bore of the tubular body when the fluid input and the nozzle adapter are secured to the tubular body, a nozzle having a first end securable to the nozzle adapter, the nozzle having a longitudinal bore that aligns with the longitudinal bore of the nozzle adapter when the nozzle is secured to the nozzle adapter, the longitudinal bore through the nozzle terminating at a fluid output at a second end of the nozzle, wherein the longitudinal bores through the tubular body, the fluid input, and the nozzle adapter each have a generally circular cross-section, wherein the fluid input has a fluid input transition to reduce the cross-sectional diameter of the longitudinal bore therethrough in a direction toward the tubular body, wherein the longitudinal bore through the nozzle has a first nozzle transition to alter the cross-sectional shape of the longitudinal bore therethrough from generally circular at the first end of the nozzle to generally rectangular at the fluid output, such that pressurized cleaning fluid delivered to the fluid input passes through the fluid output in a stream having a generally rectangular cross-section.

In another aspect the invention provides a method of cleaning electrically energized equipment, the method comprising directing a stream of pressurized cleaning fluid through a cleaning fluid input at a first end of an elongate tubular body having a second end with a nozzle attached thereto, passing the stream of pressurized cleaning fluid through a longitudinal bore of the fluid input, wherein the longitudinal bore has a fluid input transition that reduces the cross-sectional area of the longitudinal bore through the fluid input, subsequently passing the cleaning fluid through a longitudinal bore of the tubular body and into a longitudinal bore within the nozzle, passing the stream of cleaning fluid through a first nozzle transition within the nozzle to transition the stream of cleaning fluid from a generally circular cross-section to a generally rectangular cross-section, and directing the cleaning fluid through a fluid output to a surface of an electrical component to be cleaned.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a schematic view of a cleaning system for cleaning electrically energized equipment or components that employs an embodiment of the tool of the present invention.

FIG. 2 is a side elevation view of an embodiment of the tool shown in FIG. 1.

FIG. 3 is an exploded view of the tool shown in FIG. 2.

FIG. 4 is a longitudinal cross-section view through a tubular extension forming part of the main body of the tool shown in FIGS. 2 and 3.

FIG. 5 is an end view of the tubular extension shown in FIG. 4.

FIG. 6 is a side perspective view of the straight nozzle portion of the tool shown in FIGS. 2 and 3.

FIG. 7 is a perspective view of the left end of the straight nozzle shown in FIG. 6.

FIG. 8 is a perspective view of the right end of the straight nozzle shown in FIG. 6.

FIG. 9 is a longitudinal cross-section of the straight nozzle shown in FIG. 6.

FIG. 10 is a longitudinal sectional view at 90° to that shown in FIG. 9.

FIG. 11 is a cross-sectional view of the input adapter of the tool shown in FIGS. 2 and 3.

FIG. 12 is a side view of a coupling member which may be used in association with the tool shown in FIGS. 2 and 3.

FIG. 13 is a longitudinal cross section through the coupling member of FIG. 12.

FIG. 14 is a side view of a nozzle adapter use in association with the tool shown in FIGS. 2 and 3.

FIG. 15 is a longitudinal cross section through the nozzle adapter of FIG. 12.

FIG. 16 is a side view of a 90° offset nozzle that may be used in conjunction with the tool shown in FIGS. 2 and 3.

FIG. 17 is a view similar to FIG. 16 wherein the offset nozzle has been rotated in a longitudinal plane through 90°.

FIG. 18 is a side view of a 45° offset nozzle that may be used in association with the tool shown in FIGS. 2 and 3.

FIG. 19 is a view of the 45° offset nozzle of FIG. 18, rotated through 90° along a longitudinal plane.

FIG. 20 is an exploded view of a handle that may be used in association with the tool shown in FIGS. 2 and 3.

### DESCRIPTION

The present invention may be embodied in a number of different forms. The specification and drawings that follow describe and disclose some of the specific forms of the invention.

With reference to the attached drawings there is shown embodiments of a tool 1 constructed in accordance with the invention. In the particular embodiments shown, tool 1 is designed specifically for cleaning electrically energized equipment or components, however, it will be appreciated that the tool could equally be used for cleaning a wide variety of other items or objects.

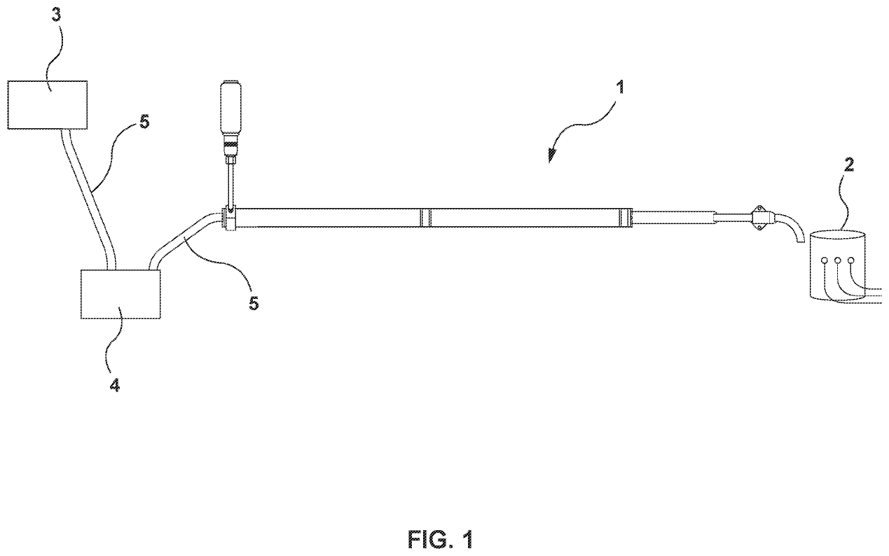

FIG. 1 is a schematic view showing, in general, a tool 1 constructed in accordance with an embodiment of the invention that utilizes a cleaning fluid comprised of a mixture of dry ice crystals (for example, having a crystal size of approximately 3 mm) and pressurized air. Tool 1 in this instance is shown as it could be used for cleaning an electrical transformer 2 that may be energized. Hoses 5 connect a source of pressurized air 3 (which is expected in most instances to be a compressor) to a dry ice machine 4 (such as that manufactured by ColdJet™), and ultimately to tool 1. Compressed air is delivered to dry ice machine 4, where the air is mixed with crystals of dry ice. The mixture of dry ice crystals and compressed air is then delivered to tool 1, after which it is directed to transformer 2 during the cleaning process.

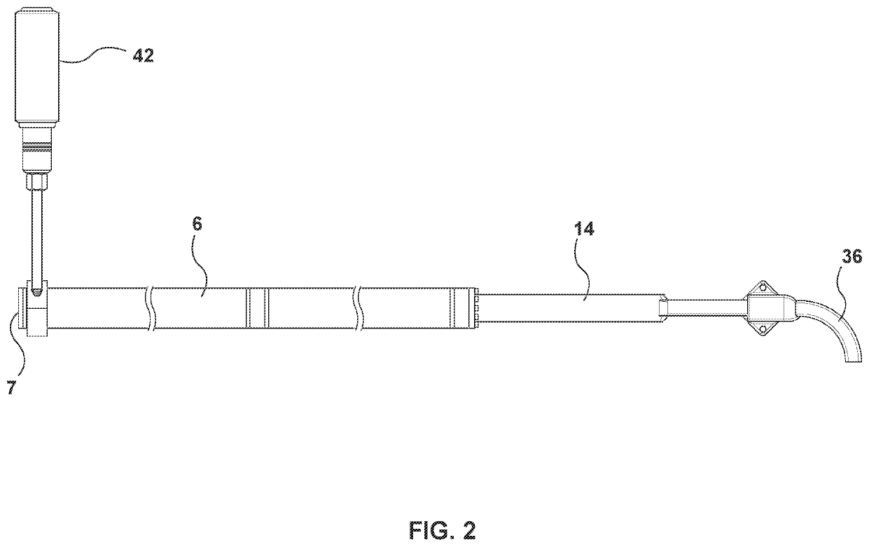

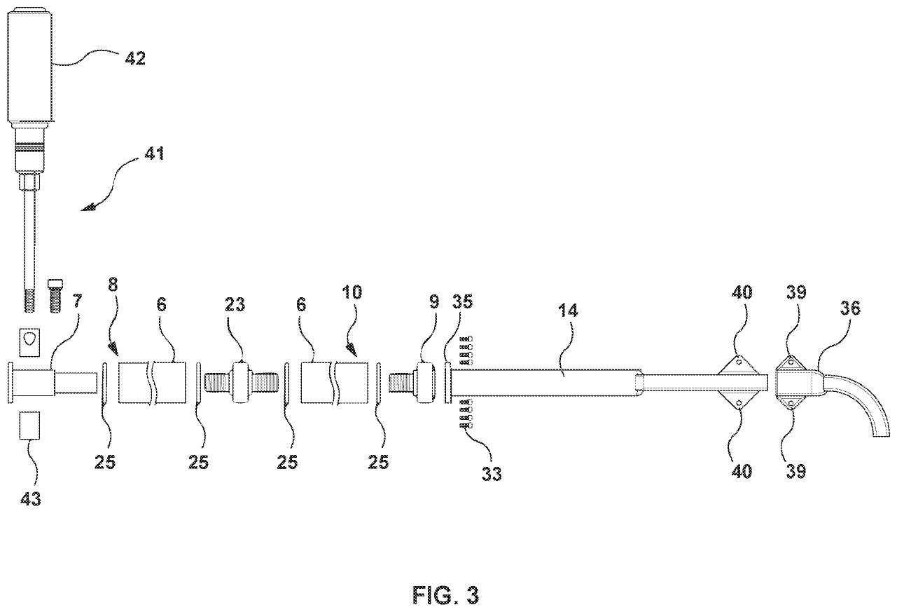

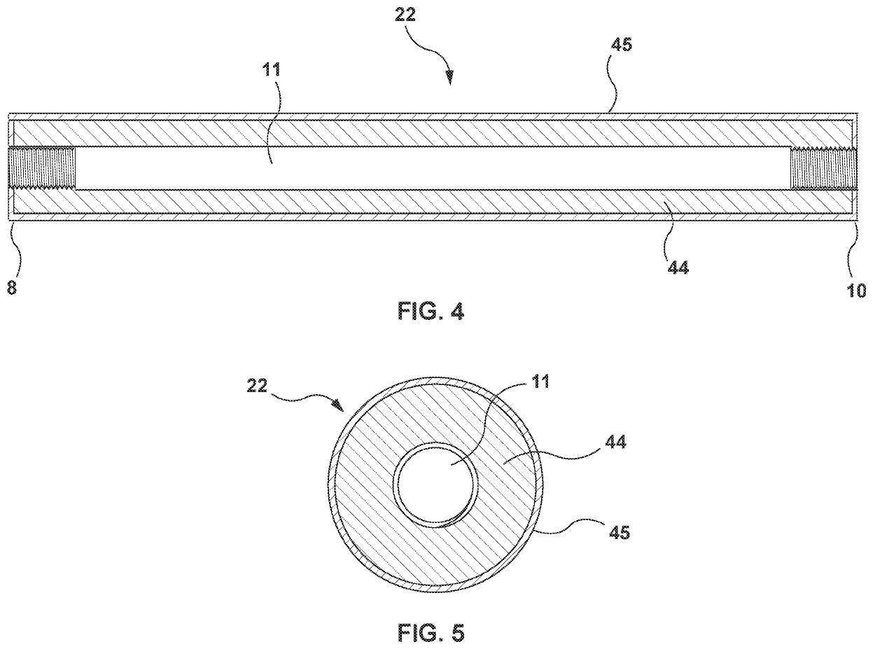

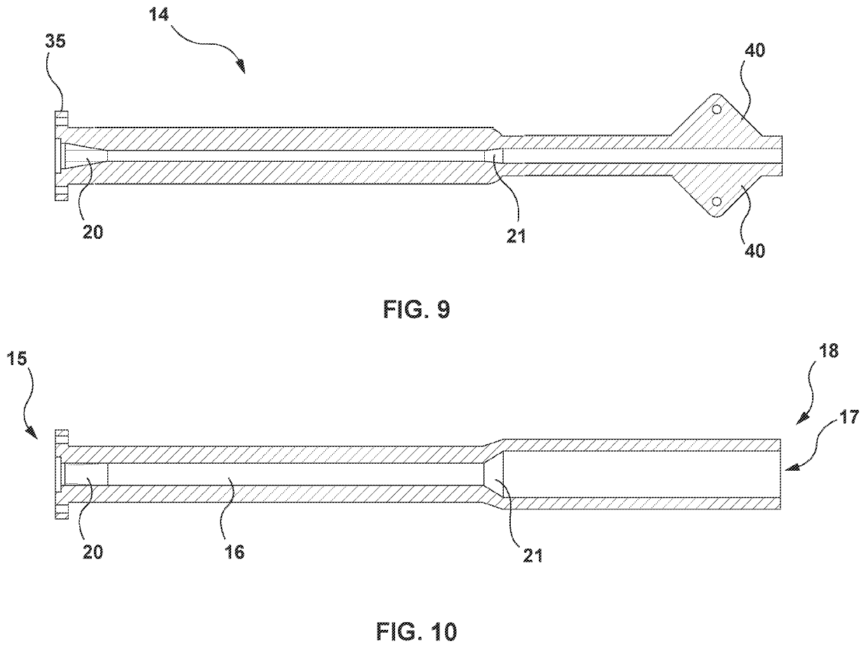

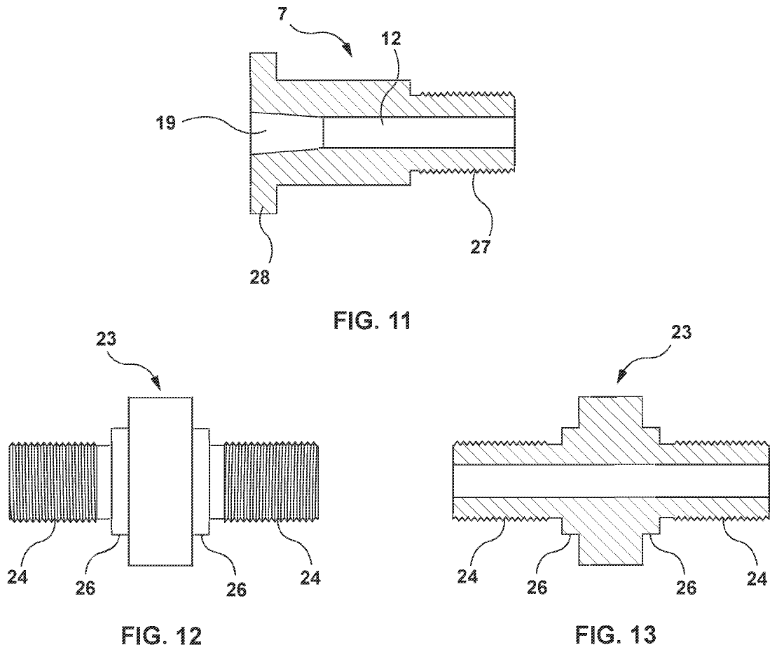

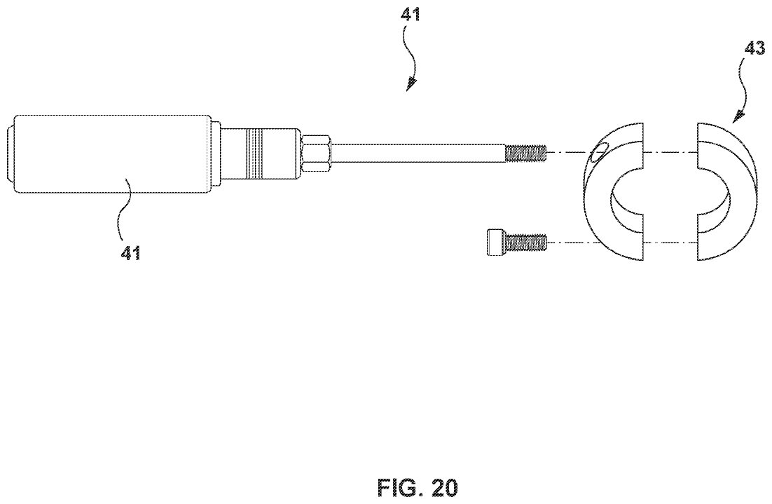

The particular construction and configuration of a preferred embodiment of tool 1 will now be described in greater detail with reference to FIGS. 2 through 20.

Tool 1 may be comprised of an elongate tubular body 6 having a cleaning fluid input 7 at a first end 8 and a nozzle adapter 9 at a second end 10. Tubular body 6 includes a longitudinal bore 11 extending from first end 8 to second end 10. Each of cleaning fluid input 7 and nozzle adapter 9 also have a longitudinal bore therethrough (12 and 13, respectively) that each align with longitudinal bore 11 when cleaning fluid input 7 and nozzle adapter 9 are secured to tubular body 6.

Tool 1 further includes a nozzle 14 having a first end 15 securable to nozzle adapter 9. Nozzle 14 has a longitudinal bore 16 that aligns with the longitudinal bore 13 of nozzle adapter 9 when nozzle 14 is secured to nozzle adapter 9. The longitudinal bore 16 of nozzle 14 terminates at a fluid output 17 positioned at a second end 18 of nozzle 14.

In an embodiment of the invention, longitudinal bores 11, 12 and 13 are generally circular in cross-section. Further, fluid input 7 may have a fluid input transition 19 to reduce the cross-sectional diameter of longitudinal bore 12 in a direction toward tubular body 6. For example, in one embodiment bore 12 may begin with a bore with a diameter of approximately 1 inch, and may be reduced by transition 19 to a diameter of approximately ½ inch. Longitudinal bore 16 through nozzle 14 may have a first nozzle transition 20 that alters the cross-sectional shape of longitudinal bore 16 from being generally circular at first end 15 of nozzle 14, to being generally rectangular at fluid output 17. With this configuration, it will be appreciated that pressurized cleaning fluid delivered to a fluid input 7 will pass through fluid output 17 in a stream having a generally rectangular cross-section.

In an embodiment of the invention, bore 16 through nozzle 14 may include a second nozzle transition 21, downstream from first nozzle transition 20, to alter the cross-sectional shape of bore 16 from a first generally rectangular cross-section to a second generally rectangular cross-section. In this embodiment, the second generally rectangular cross-section may have a width greater than that of the first generally rectangular cross-section, creating a stream of pressurized cleaning fluid exiting fluid output 17 in the form of a relatively wide and thin fan shape.

Depending upon the particular application desired for tool 1, tubular body 6 may be comprised of two or more elongate tubular portions 22, as desired for a particular application or use (see, for example, FIG. 2). In such embodiments, elongate tubular portions 22 are secured together in an end to end configuration through use of a coupling member 23, having a longitudinal bore 24 extending therethrough and aligned with the longitudinal bores of the respective tubular portions. Coupling member 23 may be comprised of a plastic or similar type material that electrically isolates the respective elongate tubular portions that it secures together in order to help prevent the transmission of an electrical charge along the length of tool 1.

It is expected that in most instances the longitudinal bores extending through individual elongate tubular portions 22 will have at least their distal ends threaded and that coupling member 23 will include opposed male threaded portions 24 that may be threadably received within the ends of respective tubular portions. It may also be desirable to place insulating spacers or washers 25 between the coupling member and the respective tubular portion 22 to which it is secured to help seal between the adjacent elements, to help prevent conductive exterior environmental particles from entering the space between the tubular portion and the coupling member, and to further help break any electrical conductivity along the length of tool 1. For example, in one embodiment washers 25 could be formed from a silicone type material that can be compressed between the end of a tubular portion and a flange 26 on coupling member 23. Further, in an embodiment coupling member 23 may be formed from a high density plastic type material, that may also include a molybdenum additive to help reduce the tendency of the coupling member to hold a capacitive and static charge (ie. to provide the coupling member with a low self-capacitance). Washers or spacers similar to washers or spacers 25 used in association with coupling member 23 may also be placed between cleaning fluid input 7 and its associated tubular portion 22, and between nozzle adapter 9 and its associated tubular portion 22.

With specific reference to FIG. 11, cleaning fluid input 7 may include a threaded portion 27 to be threadably received within a threaded end of a tubular portion 22. Cleaning fluid input 7 may also include an external flange 28 that serves as a basis upon which to mount or secure hose 5 to feed the cleaning fluid to tool 1. FIG. 11 further shows fluid input transition 19 positioned at the input and of cleaning fluid input 7, however, other locations for fluid input transition 19 are also contemplated.

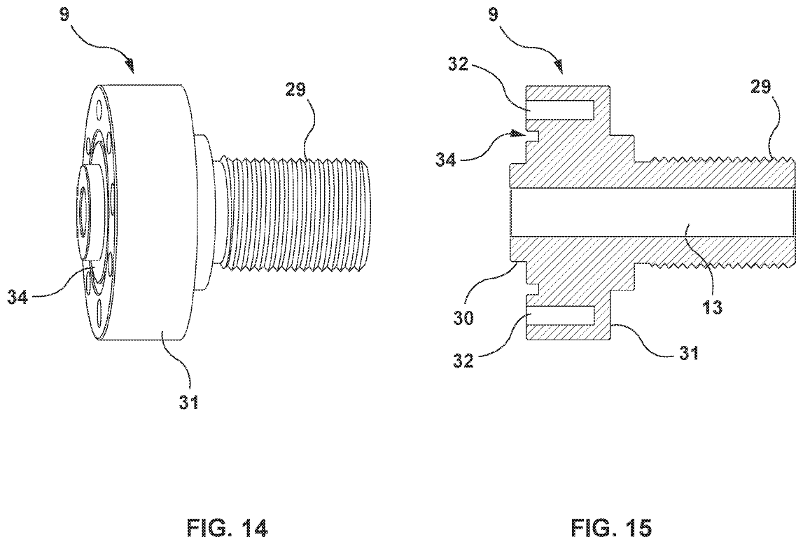

FIGS. 14 and 15 show additional details of nozzle adapter 9. In the particular embodiment shown, nozzle adapter 9 includes a threaded portion 29 which may be threadably received within a threaded end of a tubular portion 22, in a similar manner that both coupling member 23 and cleaning fluid input 7 are threadably secured to a tubular portion. Nozzle adapter 9 may also include a washer seat 30 for the receipt of a washer 25. Nozzle adapter 9 may include an exterior flange 31 having a series of the threaded bores 32 that can receive bolts 33 used to secure nozzle 14 to nozzle adapter 9. In an embodiment, the outer face of nozzle adapter 9 includes a circular channel 34 into which may be received an O-ring or other seal to present a fluid-tight connection between nozzle adapter 9 and nozzle 14.

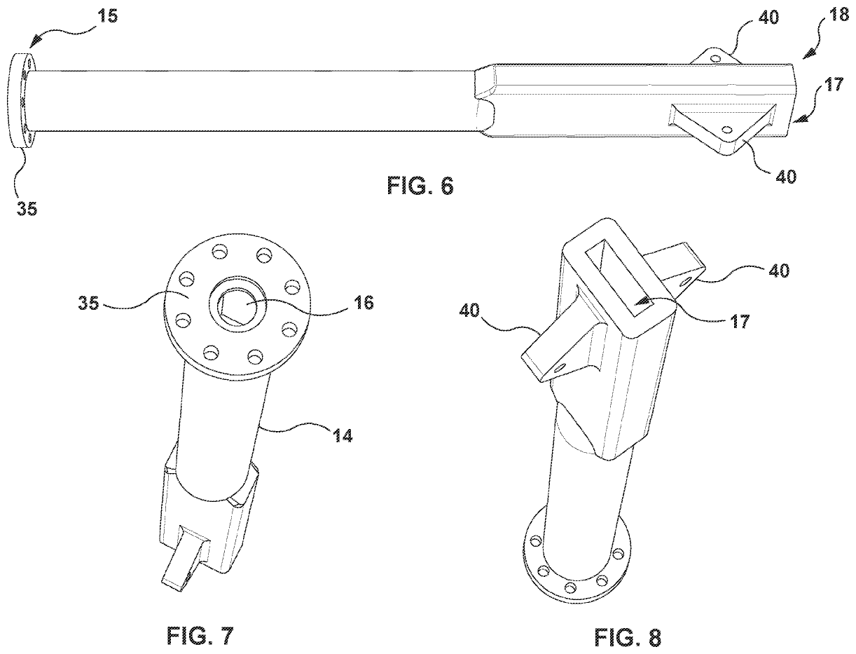

Turning next to FIGS. 6 through 10, the particular structure of nozzle 14 will now be described in further detail. In an embodiment of the invention, first end 15 of nozzle 14 includes a circumferential flange 35 which mates with the exterior surface of a flange 31 of nozzle adapter 9. Flange 35 may have a series of holes therethrough that align with threaded bores 32 in flange 31 such that bolts 33 can extend between flange 35 and flange 31 to releasably secure the nozzle to nozzle adapter 9.

As discussed, bore 16, at first end 15 of nozzle 14 has a generally circular cross-section. Within bore 16 is located first nozzle transition 20 that alters the cross-sectional shape of bore 16 from round to rectangular. In the embodiment of the invention shown, for example, bore 16 is transitioned from a circular opening of approximately 0.5 inch in diameter to a rectangular opening of approximately 0.5 inch by approximately 0.2 inch. As also discussed, in an embodiment bore 16 may include a second nozzle transition 21, downstream from first nozzle transition 20. For example, in an embodiment second nozzle transition 21 may transition the cross-sectional shape of bore 16 from an opening of approximately 0.5 inch by approximately 0.1 inch to an opening of approximately 1 inch by approximate 0.25 inch.

To enhance the ability of tool 1 to clean equipment or components having surfaces that may be difficult to reach, tool 1 may include a flow adapter 36 that is releasably securable to fluid output 17. Flow adapter 36 has an internal longitudinal bore 37 that has a configuration generally corresponding to that of fluid output 17, and that is aligned with the bore through the fluid output when flow adapter 36 is secured thereto. The flow adapter will thus serve the function of altering the trajectory of cleaning fluid exiting nozzle 14 from a path that is generally parallel to longitudinal bore 16 to a path that is at an angle to longitudinal bore 16.

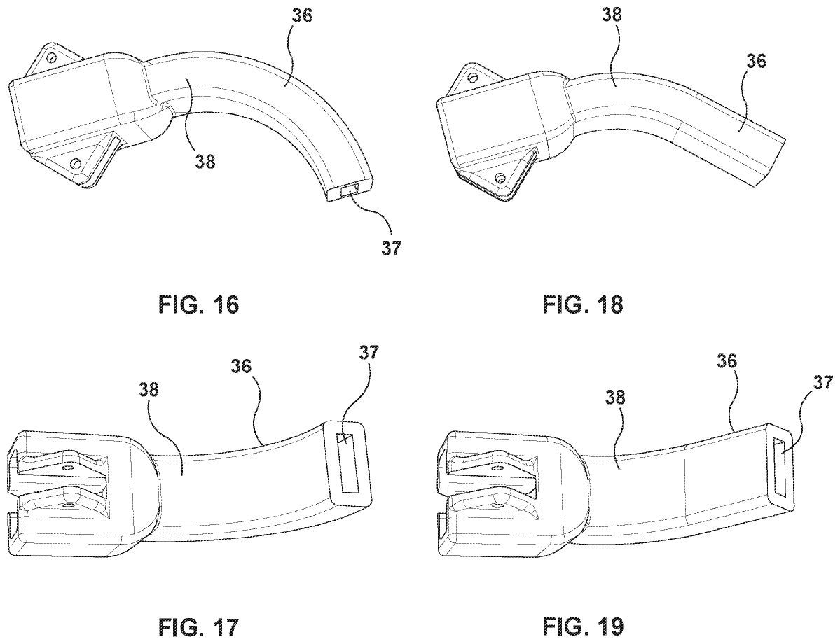

In the embodiments shown in the attached drawings, flow adapters are depicted permitting the altering of the trajectory of fluid exiting nozzle 14 at two different angles. For example, FIGS. 16 and 17 generally illustrate a flow adapter that alters the trajectory of fluid exiting nozzle 14 by approximately 90º. The embodiment of the flow adapter shown in FIGS. 18 and 19 alter the trajectory of fluid exiting the nozzle by approximately 45°. Other angles of trajectory can be created through altering the amount that body 38 of a flow adapter 36 is offset from the longitudinal axis of nozzle 14. A variety of different mechanisms can be used to secure flow adapters 36 to the second end of nozzle 18. In the embodiment shown, the flow adapters include one or more outwardly extending flanges 39 that align with flanges 40 on second and 18 of nozzle 14, and that have aligned holes that permit a bolt or other fastener to be received therethrough.

In an embodiment, tool 1 may include a handle 41 extending outwardly from tubular body 6 at approximately 90° to longitudinal bore 11. Handle 41 will help to steady tool 1 during operation and will allow an operator to more readily accommodate torque that may be applied to the tool, particularly when cleaning fluid exits flow adapter 36 at a trajectory that is at an angle to bore 16. In the particular embodiment is shown, handle 41 comprises a handgrip 42 secured to a collar 43 that may be releasably secured to the exterior surface of a tubular portion 22 at a position along the length of the tubular portion desired by an operator.

To reduce the likelihood of electrical shock to an operator when tool 1 is used in association with equipment or components that are energized with live voltage, tubular body 6 and nozzle 7 may be comprised of electrically insulative materials. Such materials will also preferably have a low electrical capacitance to help minimize the risk of a capacitive and static discharge during operation. Further, where the cleaning fluid is comprised of a mixture of dry ice crystals and air, tubular portions 22 of tubular body 6 may be comprised of thermally insulative material. For example, in an embodiment of the invention tubular portions 22 may be formed from an interior body section 44 comprised of a high density polyethylene or similar material that is surrounded on its exterior by a hard shell 45 that, for example, could be formed from fiberglass or such other material to enhance strength, rigidity, and UV resistance. It will thus be appreciated that when formed from such structures, tubular portions 22 will not only be electrically insulative, but that they will also be thermally insulative will and help protect the operator from being exposed to the extreme low temperatures that result when using dry ice crystals. It may further be advantageous to form tubular portions 22 and nozzle 14 from materials having a relatively low coefficient of expansion when the cleaning fluid includes dry ice crystals.

During operation of tool 1, a stream of pressurized cleaning fluid is delivered to cleaning fluid input 7, where it passes through bore 12 and in so doing through fluid input transition 19. In an embodiment of the invention, the reduction in the diameter of bore 12 that results from fluid input transition 19 accelerates the velocity of the cleaning fluid travelling through the tool to a supersonic, high, or accelerated velocity level. The cleaning fluid then passes through longitudinal bore 11 of tubular body 6 and into longitudinal bore 16 of nozzle 14. As the cleaning fluid first enters nozzle 14, bore 16 will have a generally circular cross-sectional diameter corresponding to that of the outer end of nozzle adapter 9. Within bore 16, the fluid will pass through first nozzle transition 20 where it's cross-sectional area will be transformed from a generally circular shape to a rectangular cross-sectional shape. The rectangular shaped stream of cleaning fluid may then be directed, at a supersonic or high velocity, to the surface of an electrical component or other object to be cleaned. In another embodiment, after passing through first nozzle transition 20, the stream of pressurized fluid passes through second nozzle transition 21 that alters the shape of the stream of pressurized fluid from a first rectangular shape to a second rectangular shape that is generally wider and of a lesser height, creating a wider and more “fan” shaped stream that exits the nozzle. Transforming the generally circular cross sectional flow of cleaning fluid to a wide and narrow fan through the use of two rectangular transitions helps to minimize the back pressure effect that may be created if a single transition were to be used.

The combination of the materials from which the various components of tool 1 is formed, together with the use of washers 25, assist in electrically isolating fluid output 17 from tubular body 6, and helps to minimize the likelihood of the transmission of an electrical charge from the end of nozzle 14 to an operator when cleaning energized equipment. Where desirable, the operator may attach a flow adapter 36 to alter the trajectory of fluid exiting nozzle 14 in a manner that assists in cleaning aspects or surfaces that may otherwise be difficult to reach.

In applications where energized electrical equipment or components are to be cleaned, as mentioned a preferred composition of the cleaning fluid is a mixture of dry ice crystals and air. Directing a stream of dry ice crystals and air at the equipment or component causes a high velocity impact of the dry ice crystals upon the surface of the component that not only helps to loosen dirt and debris, but that also causes a deposition of dry ice crystals on the surface being cleaned. Once deposited and exposed to atmospheric conditions, the dry ice crystals undergo sublimation where the solid carbon dioxide sublimates directly to a gaseous product. The resulting thermal shock has been found to help lift or remove contaminants from the surface of the component or equipment. It has further been found that the risk of the transmission of an electrical charge from the equipment to tool 1 is minimized as carbon dioxide, in either a solid crystal or a gaseous form, is highly electrically insulative. The cleaning process also results in no accumulation of cleaning media at the cleaning site. The material left to be cleaned up and disposed of thus comprises only the contaminants that have been cleaned from the surface of the equipment.

In some applications, it may also be desirable to cover or coat the entirety or a portion of the exterior surface of tool 1 with a hydrophobic material that will help to reduce electrical conductance along the outer surface of the tool through condensation of water vapour. That is, when operating under certain conditions, the cool exterior surface of the tool may cause the formation of water droplets on the tool's outer surface. Under some conditions such water droplets could represent an electrical conductor. Through coating the outer surface of the tool with a hydrophobic material (for example, silicone, wax, etc.) water vapour that may condense into droplets on the outer surface will tend to bead and run off, and be less inclined to form a continuous layer of water along the length of the tool.

It is to be understood that what has been described are the preferred embodiments of the invention. The scope of the claims should not be limited by the preferred embodiments set forth above, but should be given the broadest interpretation consistent with the description as a whole.

We claim:

1. A tool for cleaning electrically energized equipment, the tool comprising:
an elongate tubular body having a cleaning fluid input at a first end and a nozzle adapter at a second end, the tubular body having a longitudinal bore extending from the first end to the second end, each of the cleaning fluid input and the nozzle adapter having a longitudinal bore aligned with the longitudinal bore of the tubular body when the fluid input and the nozzle adapter are secured to the tubular body,
a nozzle having a first end securable to the nozzle adapter, the nozzle having a longitudinal bore that aligns with the longitudinal bore of the nozzle adapter when the nozzle is secured to the nozzle adapter, the longitudinal bore through the nozzle terminating at a fluid output at a second end of the nozzle,
wherein the longitudinal bores through the tubular body, the fluid input, and the nozzle adapter each have a generally circular cross-section,
wherein the fluid input has a fluid input transition to reduce the cross-sectional diameter of the longitudinal bore therethrough in a direction toward the tubular body,
wherein the longitudinal bore through the nozzle has a first nozzle transition to alter the cross-sectional shape of the longitudinal bore therethrough from generally circular at the first end of the nozzle to generally rectangular at the fluid output, such that pressurized cleaning fluid delivered to the fluid input passes through the fluid output in a stream having a generally rectangular cross-section.

2. The tool as claimed in claim 1 wherein the longitudinal bore through the nozzle has a second nozzle transition to alter its cross-sectional shape from a first generally rectangular cross-section to a second generally rectangular cross-section, the second generally rectangular cross-section having a width greater than that of the first generally rectangular cross-section.

3. The tool as claimed in claim 2 wherein the tubular body is comprised of one or more thermally insulative elongate tubular portions.

4. The tool as claimed in claim 2 wherein the tubular body and the nozzle are comprised of electrically insulative materials.

5. The tool as claimed in claim 4 having a flow adapter releasably securable to the fluid output, the flow adapter having an internal longitudinal bore of a configuration corresponding to that of the fluid output and aligned with the fluid output when the flow adapter is secured thereto, the flow adapter altering the trajectory of fluid exiting the nozzle from a path parallel to the longitudinal bore of the nozzle to a path that is at an angle to the longitudinal bore of the nozzle.

6. The tool as claimed in claim 5 wherein the tubular body includes a handle extending outwardly from the tubular body at approximately 90° to the longitudinal bore of the tubular body.

7. The tool as claimed in claim 4 wherein the cleaning fluid is a mixture of dry ice crystals and air, wherein the movement of the cleaning fluid through the first transition accelerates the velocity of the cleaning fluid, wherein the cleaning fluid exits the fluid output at an accelerated velocity.

8. The tool as claimed in claim 7 wherein the tubular body is comprised of two or more elongate tubular portions secured together in an end to end configuration by a coupling member having a longitudinal bore extending therethrough and aligned with the longitudinal bores of the respective elongate tubular portions, the coupling member formed from a plastic material that electrically isolates the respective elongate tubular portions.

9. The tool as claimed in claim 8 wherein the coupling member is formed from a material with a low self-capacitance to help prevent a capacitive and static discharge during use of the tool.

10. The tool as claimed in claim 9 wherein the tubular body is hydrophobic to minimize the electrical conductivity of water vapour that condenses on an exterior surface of the tubular body.

11. The tool as claimed in claim 8 comprising electrically insulating washers positioned between adjacent tubular portions.

12. A method of cleaning electrically energized equipment, the method comprising:
directing a stream of pressurized cleaning fluid through a cleaning fluid input at a first end of an elongate tubular body having a second end with a nozzle attached thereto,
passing the stream of pressurized cleaning fluid through a longitudinal bore of the fluid input, wherein the longitudinal bore has a fluid input transition that reduces the cross-sectional area of the longitudinal bore through the fluid input,
subsequently passing the cleaning fluid through a longitudinal bore of the tubular body and into a longitudinal bore within the nozzle,
passing the stream of cleaning fluid through a first nozzle transition within the nozzle to transition the stream of cleaning fluid from a generally circular cross-section to a generally rectangular cross-section, and
directing the cleaning fluid through a fluid output to a surface of an electrical component to be cleaned.

13. The method as claimed in claim 12 comprising using the fluid input transition to accelerate the speed of the flow of cleaning fluid through the longitudinal bore of the fluid input.

14. The method as claimed in claim 12 wherein the cleaning fluid exits the fluid output at an accelerated velocity.

15. The method as claimed in claim 14 wherein the velocity is supersonic.

16. The method as claimed in claim 14 wherein the cleaning fluid comprises a mixture of dry ice crystals and air, the method comprising directing the stream of cleaning fluid onto the surface of the electrical equipment to be cleaned and depositing dry ice crystals onto the surface.

17. The method as claimed in claim 16 comprising passing the stream of cleaning fluid through a second nozzle transition within the longitudinal bore of the nozzle, and positioned downstream of the first nozzle transition, to alter the rectangular cross-sectional shape of the stream of cleaning fluid from a first rectangular shape to a second rectangular shape, wherein the second rectangular shape has a width greater than that of the first rectangular shape.

18. The method as claimed in claim 17 comprising electrically isolating the fluid output of the nozzle from the tubular body.

19. The method as claimed in claim 18 comprising forming the tubular body from two or more elongate tubular portions secured together in an end to end configuration by a coupling member, and forming the coupling member from a material that electrically isolates the respective elongate tubular portions.

20. The method as claimed in claim 18 comprising coating an exterior surface of the tool with a hydrophobic material to reduce electrical conductance along the outer surface of the tool through condensation of water vapor thereon.
